(19) United States
(12) Patent Application Publication
(10) Pub. No.: US 2007/0201188 A1
(43) Pub. Date: Aug. 30, 2007

(54) Solid electrolytic capacitor and method of manufacturing solid electrolytic capacitor

(75) Inventors: Koichi Nishimura, Suita (JP); Hiroshi Nonoue, Hirakata (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi (JP)

(21) Appl. No.: 11/710,560

(22) Filed: Feb. 26, 2007

(30) Foreign Application Priority Data
Feb. 28, 2006 (JP) JP2006-054119

(51) Int. Cl. H01G 4/06; H01G 9/00; H01G 5/013

(52) U.S. Cl. 361/524

(57) ABSTRACT

A solid electrolytic capacitor including an anode formed of a conductive base body containing titanium metal. On a surface of the anode, titanium oxide is formed in which a full width at half maximum of a Raman peak of anatase-type titanium oxide is not greater than 25 cm⁻¹ in a region where the wavenumber in a laser Raman spectrum is not less than 130 cm⁻¹ nor greater than 170 cm⁻¹.

### CROSS REFERENCE TO RELATED APPLICATIONS

This application is based upon and claims the benefit of priority from prior Japanese Patent Application No. 2006-54119, filed on February 28; the entire contents of which are incorporated herein by reference.

### BACKGROUND OF THE INVENTION

1. Field of the Invention

The present invention relates to a solid electrolytic capacitor and a method of manufacturing the solid electrolytic capacitor, the solid electrolytic capacitor including an anode formed of a conductive base body containing titanium metal.

2. Description of the Related Art

Heretofore, in a solid electrolytic capacitor, a metal-oxide film, which is a dielectric, is formed on a surface of an anode, by oxidizing the surface of the anode formed of a base body containing metal in an anodizing method or the like. As such a metallic oxide, various kinds are considered, but tantalum oxide and aluminum oxide are excellent in stability. For this reason, the tantalum oxide or the aluminum oxide is formed on a surface of an anode in a solid electrolytic capacitor for practical use.

The larger the relative permittivity of a dielectric is, the larger the capacitance of the above-described solid electrolytic capacitor is. Accordingly, it is presently desired to adopt titanium oxide having a large relative permittivity as a dielectric of an anode rather than tantalum oxide or aluminum oxide having a small relative permittivity.

However, a solid electrolytic capacitor having titanium oxide formed on a surface of an anode has a problem that leakage current is large.

For example, in Japanese Patent Publication No. Heisei 5 (1993)-9790, disclosed is a solid electrolytic capacitor in which titanium oxide is formed by forming titanium nitrogen on a surface of an aluminum base body firstly, and then by oxidizing this titanium nitrogen. In the solid electrolytic capacitor of Japanese Patent Publication No. Heisei (1993)5-9790, the size of a surface of an anode can be increased, and thereby, leakage current can be reduced to some extent.

In addition, in Japanese Patent Publication No. 2004-18966, disclosed is a solid electrolytic capacitor in which a dense titanium oxide is formed on the surface of the anode. The titanium oxide is formed by anodizing a surface of an anode formed of a base body made of titanium in an electrolyte solution having a temperature of less than 10° C. In the solid electrolytic capacitor of Japanese Patent Publication No. 2004-18966, by forming the dense titanium oxide, leakage current is reduced to some extent.

In the solid electrolytic capacitors described in the above-described applications, it is possible to control leakage current to some extent. However, it is hard to say that leakage current can be sufficiently controlled. For this reason, a solid electrolytic capacitor including an anode containing titanium has not yet been put to practical use.

### SUMMARY OF THE INVENTION

The inventor of the present invention has conducted earnest studies. As a result of the studies, the inventor focused on crystallinity of titanium oxide formed on a surface of an anode. To be precise, the inventor found out that: in the case of an anode made of tantalum, the characteristics of the solid electrolytic capacitor are improved by use of amorphous tantalum oxide formed on a surface of the anode; while, in the case of an anode containing titanium, the characteristics of the solid electrolytic capacitor are improved by causing titanium oxide formed on a surface of the anode to contain an oxide having high crystallinity. Moreover, the inventor also defined the degree of crystallinity, with which the characteristics of the solid electrolytic capacitor can be improved, by using values of a full width at half maximum of a Raman peak in a laser Raman spectrum which is highly dependent on the crystallinity. As a result, the inventor has come up with the following present invention, which achieves the increase in a capacitance as well as the reduction in leakage current.

A first aspect of the present invention is a solid electrolytic capacitor. The solid electrolytic capacitor is characterized by including an anode formed of a conductive base body containing titanium metal. In the solid electrolytic capacitor, titanium oxide is formed on a surface of the anode. In the titanium oxide, a full width at half maximum of a Raman peak of anatase-type titanium oxide is not greater than 25 cm⁻¹ in a region where the wavenumber in a laser Raman spectrum is not less than 130 cm⁻¹ nor greater than 170 cm⁻¹.

In the first aspect of the present invention, it is preferable that the full width at half maximum of the Raman peak of the anatase-type titanium oxide be not less than 21 cm⁻¹ nor greater than 24 cm⁻¹.

A second aspect of the present invention is a method of manufacturing a solid electrolytic capacitor. The method includes the steps of: performing a first anodizing process for anodizing a surface of a conductive base body containing titanium metal by supplying a constant current to the base body serving as an anode, until a voltage between the base body and a cathode decreases (a first anodizing process); performing a heat treatment on the base body in a vacuum at a temperature of not less than 400° C. (a vacuum heat treatment process); and performing a second anodizing process for anodizing a surface of the base body by supplying a current to the base body, and thereby forming titanium oxide in which a full width at half maximum of a Raman peak of anatase-type titanium oxide is not greater than 25 cm⁻¹ in a region where the wavenumber in a laser Raman spectrum is not less than 130 cm⁻¹ nor greater than 170 cm⁻¹ (a second anodizing process).

### BRIEF DESCRIPTION OF THE DRAWINGS

FIG. 1 is a graph for showing a laser Raman spectrum of Example 1;

FIG. 2 is a graph for showing a laser Raman spectrum of Example 2;

FIG. 3 is a graph for showing a laser Raman spectrum of Example 3;

FIG. 4 is a graph for showing a laser Raman spectrum of Example 4;

FIG. 5 is a graph for showing a laser Raman spectrum of Example 5;

FIG. 6 is a schematic diagram for describing a full width at half maximum;

FIG. 7 is a graph for showing a relationship between a capacitance and a full width at half maximum of a Raman peak in each of Examples 1 to 4 and Comparative Example 1;

FIG. 8 is a graph for showing a relationship between a leakage current and a full width at half maximum of a Raman peak in each of Examples 1 to 4 and Comparative Example 1;

FIG. 9 is a graph for showing a relationship between a capacitance and a full width at half maximum of a Raman peak in each of Examples 5 to 9 and Comparative Examples 2 to 4;

FIG. 10 is a graph for showing a relationship between a leakage current and a full width at half maximum of a Raman peak in each of Examples 5 to 9 and Comparative Examples 2 to 4; and

FIG. 11 is a graph for showing changes in voltage of a first anodizing process.

### DETAILED DESCRIPTION OF THE PREFERABLE EMBODIMENTS

A solid electrolytic capacitor manufactured by using a method of manufacturing of the present invention includes an anode formed of a conductive base body containing titanium, which is valve metal (“valve metals” are those elements which form anodic oxide films having rectifying properties). A surface of the anode contains titanium oxide, which increases capacitance, and which also reduces a leakage current. To be precise, in the case of this titanium oxide, a full width at half maximum of a Raman peak of anatase-type titanium oxide is not greater than about 25 cm⁻¹ in a region where the wavenumber in a laser Raman spectrum is not less than about 130 cm⁻¹ greater than about 170 cm⁻¹. Furthermore, it is preferable that titanium oxide having the following characteristic be formed on an anode. In the titanium oxide, a full width at half maximum of a Raman peak of anatase-type titanium oxide is not less than about 21.0 cm⁻¹ nor greater than about 24.0 cm⁻¹, in a region where the wavenumber in a laser Raman spectrum is not less than about 130 cm⁻¹ nor greater than about 170 cm⁻¹.

Next, a method of manufacturing a solid electrolytic capacitor of the present invention is described.

### (Manufacturing of Anode)

First, in a first anodizing process, a titanium foil or the like is cut into a desired shape, and this titanium foil (a base body) is subjected to ultrasonic-cleaning in acetone for 5 minutes. Subsequently, the titanium foil is cleaned by using purified water, and thereafter is dried in a constant temperature bath at a temperature of 60° C. for about 30 minutes. Next, in a 0.1 wt % phosphoric acid solution maintained at a temperature of 30° C., by supplying, between the titanium foil as an anode and a cathode, a constant current with a current density of about 3 mA/cm², the titanium foil is anodized for about 5 minutes to 90 minutes. Thereby, on a surface of the titanium foil, crystal nuclei of anatase-type titanium oxide are formed.

Here, as shown in FIG. 11, a voltage between the anode (titanium foil) and the cathode during the anodization increases substantially linearly for the first several tens of seconds since the formation of a titanium oxide film increases its resistance. After the voltage reaches about 7 V, the formed titanium oxide is gradually crystallized and the resistance caused by the titanium oxide film decreases. Thereby, the voltage decreases down to about 6 V. Subsequently, the voltage becomes stable around 6 V for about 30 minutes after the application of a voltage. However, the titanium oxide film grows, and thus the resistance increases again. Hence, the voltage again starts to increase moderately at about 30 minutes after the application of the voltage. The voltage between the anode and the cathode increases to about 10 V at about 60 minutes after the application of the voltage, and to about 15 V at about 90 minutes after the application of the voltage.

Next, in a drying treatment process, the anodization is terminated after a desired period of time, and the titanium foil is cleaned using purified water. Thereafter, the titanium foil is dried in a constant temperature bath at a temperature of 60° C. for about 30 minutes.

Subsequently, in a vacuum heat treatment process, a vacuum heat treatment is performed on the titanium foil at a temperature of about 400° C. to 900° C. for about 60 minutes in a vacuum of about 6×10⁻⁴ Pa. Thereby, the titanium oxide further grows from the nucleus of the crystal of the titanium oxide formed in the first anodizing process.

Next, in a second anodizing process, the titanium oxide is sufficiently cooled down and taken out. Then the titanium oxide is again anodized at a constant voltage of about 15 V for about 30 minutes in a 0.1 wt % phosphoric acid solution maintained at a temperature of 30° C. Thereby, defects occurred in the titanium oxide during the vacuum heat treatment process were repaired.

### (Manufacturing of a Solid Electrolytic Capacitor)

Subsequently, by using the anode manufactured according to the above-described processes of manufacturing an anode, a solid electrolytic capacitor is manufactured by using a known process.

A solid electrolytic capacitor of the present invention includes an anode containing titanium oxide having the following characteristic. In the titanium oxide, a full width at half maximum of a Raman peak of anatase-type titanium oxide is not greater than about 25 cm⁻¹ in a region where the wavenumber in a laser Raman spectrum is not less than about 130 cm⁻¹ nor greater than about 170 cm⁻¹. This makes it possible to increase the capacitance. Moreover, by use of a dense titanium oxide, defects in the crystal serving as a passage of current can be reduced. Thereby, the leakage current can be reduced. Furthermore, by forming titanium oxide in which a full width at half maximum of a Raman peak of anatase-type titanium oxide is not less than about 21.0 cm⁻¹ nor greater than about 24.0 cm⁻¹ in a region where the wavenumber in a laser Raman spectrum is not less than about 130 cm⁻¹ nor greater than about 170 cm⁻¹, the leakage current can be further controlled.

### EXAMPLES

Experiments conducted to verify the above-described effect are described.

### Experiment 1

### Relationship Between Voltage Application Time in a First Anodizing Process and Characteristics of an Anode of a Solid Electrolytic Capacitor

First, methods of manufacturing anodes of Examples 1 to 4 and of Comparative Example 1 for Experiment 1 are described. The anode of Comparative Example 1 was manufactured for comparison. Processes of manufacturing anodes of the respective Examples 1 to 4 are different from the process of manufacturing the above-described anode only with respect to voltage application time in the first anodizing process. Therefore, only first anodizing processes of the respective Examples and the Comparative Example are described as follows. Incidentally, in Examples 1 to 4 and Comparative Example 1, the above-described vacuum heat treatment was performed at a temperature of about 600° C.

### Example 1

First, a titanium foil having a thickness of about 0.1 mm was cut into a rectangular shape, and this titanium foil was subjected to ultrasonic cleaning in acetone for 5 minutes. Next, this titanium foil was anodized at a current density of 3 mA/cm² for about 5 minutes in phosphoric acid solution of about 0.1 wt % which was maintained at a temperature of 30° C. Thereby, on a surface of the titanium foil, a nucleus of crystal of anatase-type titanium oxide was formed. Incidentally, after about 5 minutes from the time when the anodizing started, the voltage moderately decreased after the voltage of the anode reaches about 7 V. Accordingly, in the first anodizing process of Example 1, a nucleus of a titanium oxide film was crystallized to some extent.

### Example 2

In Example 2, a used method of manufacturing an anode was the same as that of Example 1 except that the anode was anodized for about 30 minutes in a first anodizing process. Incidentally, after about 30 minutes from the time when the anodizing started, the voltage of the anode rarely decreased and was in a stable state of about 6 V. Accordingly, in the first anodizing process of Example 2, a nucleus of a titanium oxide film was almost crystallized.

### Example 3

In Example 3, a method of manufacturing an anode was the same as that of Example 1 except that the anode was anodized for about 60 minutes in a first anodizing process. Incidentally, after about 60 minutes from the time when the anodizing started, the voltage of the anode again increased and reached about 10 V. Accordingly, in the first anodizing process of Example 3, a nucleus of a titanium oxide film was almost crystallized, and, from the nucleus thereof, the titanium oxide film grew.

### Example 4

In Example 4, a method of manufacturing an anode was the same as that of Example 1 except that the anode was anodized for about 90 minutes in a first anodizing process. Incidentally, after about 90 minutes from the time when the anodizing started, the voltage of the anode further increased and reached about 15 V. Accordingly, in the first anodizing process of Example 4, a nucleus of a titanium oxide film was almost crystallized, and, from the nucleus thereof, the titanium oxide film grew more than the level of that of Example 3.

### Comparative Example 1

In Comparative Example 1, a method of manufacturing an anode was the same as that of Example 1 except that the anode was anodized for about 30 seconds in a first anodizing process. Incidentally, after about 30 seconds from the time when the anodizing started, the voltage of the anode reached about 7 V. Accordingly, in the first anodizing process of Comparative Example 1, a nucleus of a titanium oxide film was merely crystallized.

Next, measurement methods used for measuring characteristics of the respective Examples 1 to 4 and Comparative Example 1 are described.

### (Measuring of Laser Raman Spectrum and Calculation of a Full Width at Half Maximum of a Raman Peak)

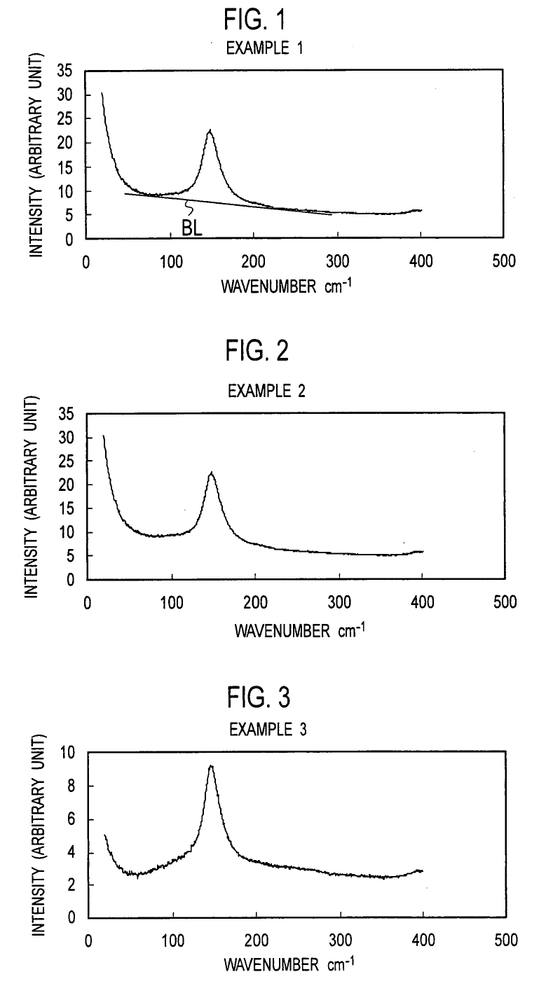

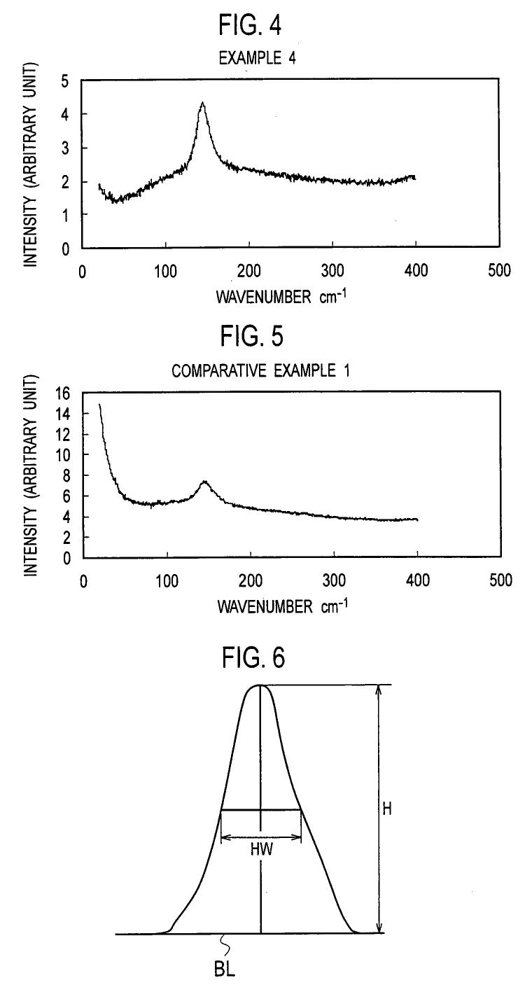

Laser Raman spectrum was obtained in a micro-Raman mode where a measurement device of micro-Raman was set at 60 degrees scanning. To be precise, the Ar⁺ laser (GLG3460 manufactured by NEC) of about 5145 Å was used as a light source, a laser power was set at about 200 mW, a spot diameter of a laser was set at about 100 μm, and a slit of the spectrometer was set at about 100 μm. Accordingly, a laser Raman spectrum was obtained from average information obtained from the irradiation area of the laser. Laser Raman spectra obtained in the cases of Examples 1 to 4 and Comparative Example 1 are shown in FIGS. 1 to 5. Note that, FIG. 6 is a schematic diagram for describing a full width at half maximum.

A straight baseline BL (refer to FIG. 1) is drawn so as to be tangent to a laser Raman spectrum on both areas which sandwich a Raman peak of anatase-type titanium oxide between about 130 cm⁻¹ and about 170 cm⁻¹ of the wavenumber of the laser Raman spectrum obtained in the above-described manner. This baseline BL was used as a background. Curve fitting was performed on a Raman peak with a baseline BL drawn as shown in FIG. 6 according to a least-squares method by using a Lorentzian function. Thereby a full width at half maximum was obtained at a position of half the height H of a Raman peak. Note that, some deviations may occur in full width at half maximums depending on setting of a baseline BL, but they are just fractions on the order of two places of decimals and are in an error range.

### (Measuring of Capacitance)

A capacitance was measured with an anode and a counter electrode of respective Examples and Comparative Example immersed in ammonium adipic acid solution. The ammonium adipic acid solution was obtained by dissolving ammonium adipic acid of about 150 g into purified water of about 1 L. To be precise, an Al electrode whose surface area was increased by etching was used as a counter electrode, and a capacitance was measured using an LCR meter under the conditions of about 120 Hz and about 100 mV.

### (Measuring of Leakage Current)

Phosphoric acid solution of about 0.1 wt %, which was maintained at a temperature of 30° C., was put into an SUS304-made water bath. Then, in the phosphoric acid solution, the anode of respective Examples and Comparative Example was immersed. A direct current voltage of about 2.5 V was applied to the anode of respective Examples and Comparative Example with the SU304-made container used as a ground, and a current flow was measured. As a value of a leakage current, adopted was a current value measured about 5 minutes after the application of the voltage.

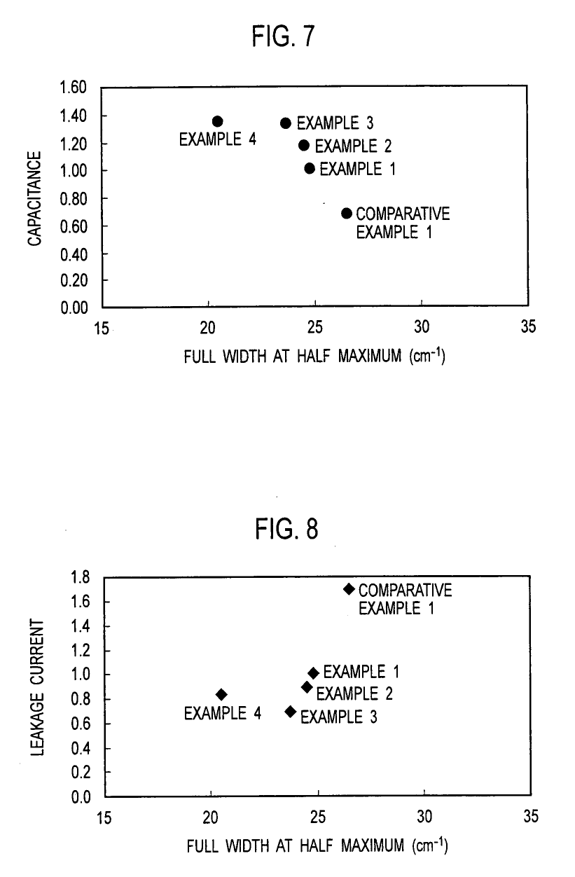

Results of the full width at half maximums of the Raman spectrum, the capacitances and the leakage currents are shown in Table 1 and FIGS. 7, 8. The capacitance and the leakage current of Example 1 are set at “1,” and those in Examples 2 to 4 and Comparative Example 1 were normalized. FIG. 7 is a graph for showing a relationship between capacitances in Table 1 and full width at half maximums of Raman peaks, and FIG. 8 is a graph for showing a relationship between leakage currents in Table 1 and full width at half maximums of Raman peaks.

TABLE 1

| | Full width | | |
|---|---|---|---|
| | at half | Capacitance | Leakage current |
| | maximum | (normalized with | (normalized with |
| | (cm⁻¹) | respect to Example 1) | respect to Example 1) |
| Example 1 | 24.8 | 1.00 | 1.00 |
| Example 2 | 24.5 | 1.17 | 0.89 |
| Example 3 | 23.7 | 1.33 | 0.69 |
| Example 4 | 20.5 | 1.35 | 0.83 |
| Comparative | 26.5 | 0.67 | 1.70 |
| Example 1 | | | |

As shown in Table 1 and FIG. 7, in the first anodizing process, as a result of supplying current for a predetermined period of time or more, the capacitance was “1.00” or greater in each of Examples 1 to 4 in each of which the full width at half maximum was not greater than about 24.8 cm⁻¹. Meanwhile, in the first anodizing process, since the nucleus of the titanium oxide film was not crystallized, the capacitance of Comparative Example 1 where the full width at half maximum was about 26.5 cm⁻¹ became so small, that is, “0.67.” From these results, it can be seen that the capacitance is increased in each of Examples 1 to 4.

Moreover, as shown in Table 1 and FIG. 8, the leakage current was “1.00” or lesser in each of Examples 1 to 4 in each of which the full width at half maximum was not greater than about 24.8 cm⁻¹. Meanwhile, the leakage current of Comparative Example 1 where the full width at half maximum was about 26.5 cm⁻¹ became so large, that is, “1.70.” It is considered that the reason why such results were obtained is because there is a small amount of defects in the crystal serving as the passage of current in each Examples 1 to 4. From the results, it can be seen that the leakage current can be reduced in Examples 1 to 4 of the present invention. Especially, it can be seen that, in Example 3 in which the full width at half maximum was about 23.7 cm⁻¹, the leakage current was “0.69” so that further reduction of the leakage current is possible.

### Experiment 2

### Relationship Between Temperature of Heat Treatment in Vacuum Heat Treatment Process and Characteristics of Anode of Solid Electrolytic Capacitor

Described are methods of manufacturing anodes of Examples 5 to 9 for Experiment 2, and methods of manufacturing anodes of Comparative Examples 2 to 4 for comparison. In each of Examples 5 to 9 and Comparative Examples 2 to 4, a process of manufacturing anodes is different in a processing temperature in a vacuum heat treatment process from the processes of manufacturing anodes in Examples described above. Accordingly, hereinafter, only vacuum heat treatment process for each of Examples and Comparative Examples are described. In addition, in each of Examples 5 to 9 and Comparative Examples 2 to 4, a constant current is supplied for about 60 minutes in the first anodizing process corresponding to those of the above-describe Examples.

### Example 5

In the above-described vacuum heat treatment process, vacuum heat treatment was performed on a titanium foil after drying, at a temperature of about 400° C. for about 60 minutes in a vacuum of about 6×10⁻⁴ Pa.

### Example 6

In the above-described vacuum heat treatment process, vacuum heat treatment was performed on a titanium foil after drying, at a temperature of about 500° C. for about 60 minutes in a vacuum of about 6×10⁻⁴ Pa.

### Example 7

In the above-described vacuum heat treatment process, vacuum heat treatment was performed on a titanium foil after drying at a temperature of about 600° C. for about 60 minutes in a vacuum of about 6×10⁻⁴ Pa.

### Example 8

In the above-described vacuum heat treatment process, vacuum heat treatment was performed on a titanium foil after drying at a temperature of about 700° C. for about 60 minutes in a vacuum of about 6×10⁻⁴ Pa.

### Example 9

In the above-described vacuum heat treatment process, vacuum heat treatment was performed on a titanium foil after drying at a temperature of about 900° C. for about 60 minutes in a vacuum of about 6×10⁻⁴ Pa.

### Comparative Example 2

In the above-described vacuum heat treatment process, vacuum heat treatment was performed on a titanium foil after drying at a temperature of about 200° C. for about 60 minutes in a vacuum of about 6×10⁻⁴ Pa.

### Comparative Example 3

In the above-described vacuum heat treatment process, vacuum heat treatment was performed on a titanium foil after drying at a temperature of about 300° C. for about 60 minutes in a vacuum of about 6×10⁻⁴ Pa.

### Comparative Example 4

An anode was manufactured without performing the above-described vacuum heat treatment process.

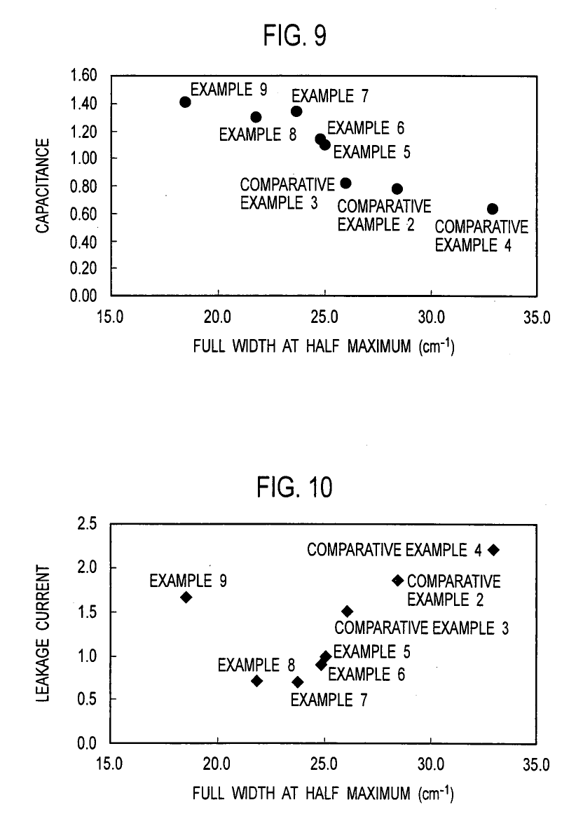

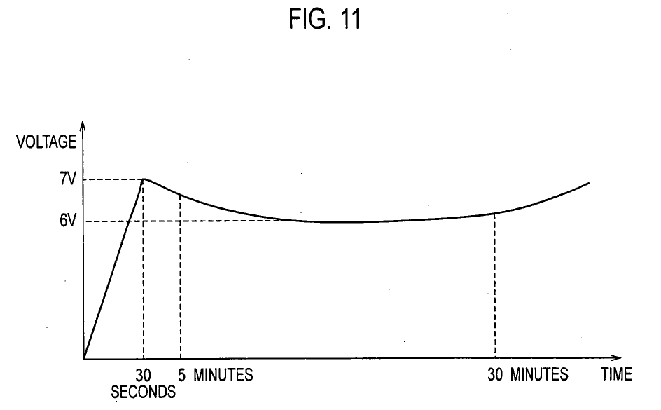

For each of Examples 5 to 9 and Comparative Examples 2 to 4, as in the case of Experiment 1, laser Raman spectrum was obtained. As in the case of Experiment 1, the full width at half maximum was calculated using obtained laser Raman spectra, and the capacitance and the leakage currents were measured. In addition, the capacitances and the leakage currents were normalized with respect to those of Example 1. Results are shown in Table 2 and FIGS. 9, 10. FIG. 9 is a graph for showing relationships between the capacitances in Table 2 and the corresponding full width at half maximums of Raman peaks, respectively, and FIG. 10 is a graph for showing relationships between the leakage currents in Table 2 and the corresponding full width at half maximums of Raman peaks, respectively.

TABLE 2

| | Full width | | |
|---|---|---|---|
| | at half | Capacitance | Leakage current |
| | maximum | (normalized with | (normalized with |
| | (cm⁻¹) | respect to Example 1) | respect to Example 1) |
| Example 5 | 25.0 | 1.09 | 0.98 |
| Example 6 | 24.8 | 1.13 | 0.89 |
| Example 7 | 23.7 | 1.33 | 0.69 |
| Example 8 | 21.8 | 1.29 | 0.71 |
| Example 9 | 18.5 | 1.40 | 1.65 |
| Comparative | 28.4 | 0.77 | 1.85 |
| Example 2 | | | |
| Comparative | 26.0 | 0.81 | 1.49 |
| Example 3 | | | |
| Comparative | 32.9 | 0.63 | 2.20 |
| Example 4 | | | |

As shown in Table 2 and FIG. 9, in each of Examples 5 to 9, in each of which vacuum heat treatment process was performed at a temperature not less than about 400° C. and crystallization of titanium oxide was accelerated so that the full width at half maximum was not greater than about 25.0 cm⁻¹, the capacitance was not less than “1.09”. Meanwhile, in each of Comparative Examples 2 to 4, in each of which vacuum heat treatment process was performed at a temperature not greater than about 300° C. and crystallization of titanium oxide was not accelerated so that the full width at half maximum was not less than about 26.0 cm⁻¹, the capacitance became so small, that is, not greater than “0.81”. Accordingly, it can be seen that, in each of Examples 5 to 9 of the present invention, the capacitance can be increased.

Furthermore, as shown in Table 2 and FIG. 10, in each of Examples 5 to 9 in each of which the full width at half maximum was not greater than about 25.0 cm⁻¹, the leakage current was not greater than “0.98”. Meanwhile, in each of Comparative Examples 2 to 4 in each of which the full width at half maximum was not less than about 26.0 cm⁻¹, the leakage current became so large, that is, not less than “1.49.” It can be considered that the reason why such results were obtained is because there was not a large amount of defects in the crystal and a small number of pass for current, in each of Examples 5 to 8. Accordingly, it can be seen that, in each of Examples 5 to 8 of the present invention, the leakage current can be reduced. Especially, it is seen that, in each of Examples 7 and 8 in each of which the full width at half maximum was from about 23.7 cm⁻¹ to about 21.8 cm⁻¹, the leakage current was not greater than “0.71”. According to these results, a leakage current can be further reduced in each of Examples 7 and 8.

Although the present invention has been described in detail using the above-described embodiments, it is obvious to those skilled in the art that the present invention is not limited to the above-described embodiments described in the present application. Variations and modifications may be made on the present invention without departing from the spirit and the scope of the present invention. Descriptions of the present specification are therefore to be considered in all respects as illustrative and not restrictive.

What is claimed is:

1. A solid electrolytic capacitor comprising an anode formed of a conductive base body containing titanium metal,
wherein titanium oxide is formed on a surface of the anode, in which a full width at half maximum of a Raman peak of anatase-type titanium oxide is not greater than 25 cm⁻¹ in a region where the wavenumber in a laser Raman spectrum is not less than 130 cm⁻¹ nor greater than 170 cm⁻¹.

2. The solid electrolytic capacitor according to claim 1, wherein the full width at half maximum of the Raman peak of the anatase-type titanium oxide is not less than 21 cm⁻¹ nor greater than 24 cm⁻¹.

3. A method of manufacturing a solid electrolytic capacitor, comprising the steps of:
performing a first anodizing process for anodizing a surface of a conductive base body containing titanium metal by supplying a constant current to the base body serving as an anode, until a voltage between the base body and a cathode decreases;
performing a heat treatment on the base body in a vacuum at a temperature of not less than 400° C.; and
performing a second anodizing process for anodizing a surface of the base body by supplying a current to the base body, and thereby forming titanium oxide in which a full width at half maximum of a Raman peak of anatase-type titanium oxide is not greater than 25 cm⁻¹ in a region where the wavenumber in a laser Raman spectrum is not less than 130 cm⁻¹ nor greater than 170 cm⁻¹.
